(19) United States
(12) Patent Application Publication
(10) Pub. No.: US 2026/0035085 A1
(43) Pub. Date: Feb. 5, 2026

(54) Autorotation System for Helicopters Using Electric Propeller Torque Arm as Power Source Driving Main Rotor

(71) Applicants: Dawei Dong, MOSELEY, VA (US); DAWIT HAILE, MOSELEY, VA (US); Nengliang Yao, Glen Allen, VA (US)

(72) Inventors: Dawei Dong, MOSELEY, VA (US); DAWIT HAILE, MOSELEY, VA (US); Nengliang Yao, Glen Allen, VA (US)

(73) Assignee: eVTOL Innovation, Inc., North Dinwiddie, VA (US)

(21) Appl. No.: 18/675,759

(22) Filed: May 28, 2024

(51) Int. Cl. B64D 35/021; B64C 29/00; B64D 31/09; B64F 5/60

(52) U.S. Cl. CPC B64D 35/021; B64C 29/00; B64D 31/09; B64F 5/60

(57) ABSTRACT

Flight safety of electric vertical take-off and landing (eVTOL) aircrafts is a matter of life and death, crucial to their future regulatory and market acceptance as the next generation of aerial vehicles. Only those aircraft equipped with a safe emergency landing system will be selected for human use, but the current eVTOL models lack reliable emergency landing systems. The first inventor, who already holds patents for an eVTOL helicopter with an electric propeller torque arm (EPTA) driving the main rotor—featuring high efficiency, structural simplification, zero emissions, and low noise—successfully completed test flights and then invented the safest, most innovative autorotation landing system. This system significantly enhances and optimizes the traditional helicopter's inherent autorotation landing capability, ensuring a critical safety measure for eVTOLs during power system failures. Thus, this invention of the safety landing system will help make the safest vertical take-off and landing aircraft eligible for market acceptance.

### CROSS-REFERENCE TO RELATED APPLICATIONS

U.S, Pat. No. 11,130,565 Sep. 28, 2021 DAWEI DONG

U.S, Pat. No. 10,723,449 Jul. 28, 2020 DAWEI DONG

U.S, Pat. No. 10,604,241 Mar. 31, 2020 DAWEI DONG

### BACKGROUND OF THE INVENTION

Traditional helicopters, with a history of nearly eighty years, have the capability for safe autorotation landings. Every helicopter pilot must learn and master this essential flight technique. Our helicopter, driven by an electric propeller torque arm (EPTA), also possesses the capability for safe autorotation landing.

In traditional helicopters, when a power system failure occurs, the collective pitch control (or simply “collective” or “thrust lever”) of the main rotor must be immediately lowered to the minimum, reducing the angle of attack of the rotor blades to approximately 2°-3°, corresponding to a blade tip speed of about 165 meters per second. At this point, the lift direction of the helicopter rotor blade profile changes from the root to the tip of the rotor blade. Part of the aerodynamic force tilts forward, generating a driving torque that continues to rotate the rotor forward, while another part of the rotor disc area experiences a resisting torque. When the driving torque equals the resisting torque, the net torque is zero, and the rotor maintains continuous rotation due to its existing inertia. At this moment, the lift generated by the rotor blades allows the helicopter to descend gently, akin to the way a maple seed drifts to the ground.

The second step is to push the control stick of the helicopter forward to maintain a forward flight speed of several tens of kilometers per hour. This changes the airflow from entering the rotor from the upper front to entering from the lower front. At this point, the pilot should search for a safe landing site. If it is necessary to hover and look for a landing site, the cyclic pitch can still be controlled, but this will reduce the rotor's inertial speed and increase the descent rate. However, our EPTA's emergency drive function will continue to push the rotor to overcome the resisting torque, maintaining the required rotation per minute (RPM) for autorotation.

The third step is the final maneuver before landing: raising the collective pitch control to the maximum. This utilizes the rotor's inertia to achieve the greatest and final lift, similar to a bird spreading its wings wide to land on its feet. However, due to the lack of experience in executing this final maneuver, some pilots of traditional helicopters may still cause the helicopter to land quite hard.

Vertical take-off and landing aircrafts equipped with emergency safe landing systems are more likely to be adopted by users. However, current eVTOL models, including multi-rotors and tiltrotors, lack reliable emergency landing systems. Multi-rotors, which use multiple propellers for lift and stability, can face significant challenges if one propeller fails. Tiltrotors, combining the vertical lift capability of helicopters with the speed of airplanes, also lack proven emergency mechanisms for safe landings, particularly during the tilting phase.

In case of an emergency landing, our helicopter, driven by an EPTA system, requires reducing the rotor blade angle of attack as the first step when the drive motor malfunctions, similar to traditional helicopters. This quickly brings the sum of the driving torque and the resisting torque to zero, entering inertial autorotation.

Secondly, we will immediately jettison the battery pack, which weighs 35% of the takeoff weight. We retain a 5-kilogram emergency motor with a two-minute limit power supply. This action reduces the rotor disc loading by 35%, thereby decreasing the autorotation descent rate of the helicopter. (For comparison, the rotor disc loading of the Robinson R-44 helicopter is approximately 14 kg/m²; our first-generation ultralight EPTA helicopter has a rotor disc loading of 10 kg/m². After jettisoning the emergency battery, the rotor disc loading is less than 7 kg/m². This is analogous to two parachutes of the same size, one carrying a 100-kilogram person and the other carrying less than 70 kilograms. The descent rate is significantly reduced for the second parachute, as is evident.)

The first part of our patent application is: our EPTA power system is designed with a second set of emergency drive motors and emergency batteries. When this emergency system is activated, the rotor's autorotation speed is maintained at an optimal level. This allows for controlled descent rates even while hovering to find a safe landing spot. During the final landing process, the rotor does not rely solely on inertia. The EPTA can also accelerate the main rotor at the last moment, enabling our EPTA helicopter to achieve a safe and soft landing. This is an innovative capability that traditional helicopters cannot match!

The second part is the jettisoning of the battery pack, which accounts for 35% of the takeoff weight. This action immediately reduces the rotor disc loading by 35%, thereby decreasing the descent rate.

The third part involves the final landing procedures, where we have implemented a multi-redundant autonomous autorotation landing system, utilizing LiDAR, computer vision, and pre-touchdown tactile feedback. This method of autorotation landing, assisted by the EPTA system, is an unprecedented innovative invention. It makes the autorotation landing of the electric helicopter nearly perfect, positioning it as the safest and most reliable prototype among all forms of eVTOL.

Therefore, we are applying for patent protection to facilitate its widespread use.

### SUMMARY OF THE INVENTION

The invention involves a push-pull propeller on the torque arm. The main motor drives the torque arm through a transmission shaft, overcoming the resisting torque to rotate the main rotor. The main motor's output shaft is equipped with a one-way clutch torque drive bearing. In the event of a malfunction in the main drive motor or the primary power supply system, fault sensors—monitoring parameters such as motor speed, temperature, power supply voltage, and current-automatically detect the power failure and immediately shut down the main motor system. Simultaneously, a high-energy, short-duration emergency small motor drive system is activated. This emergency system includes a high-energy, high-current emergency battery and a dedicated emergency motor. It allows the torque arm to continue driving the main rotor for about two minutes in an emergency, overcoming the resisting torque, maintaining rotor autorotation speed, reducing the descent rate, and enabling the search for a safe landing site.

At the same time, when a fault is detected in the battery power system or the battery itself, a single button automatically jettisons the battery system, which constitutes 35% of the helicopter's total weight. Then, the collective pitch control is lowered, reducing the rotor blade angle of attack to 2°-3°. The control stick is pushed to maintain forward flight speed, entering the optimal autorotation landing state.

As the helicopter approaches the ground, the altitude LiDAR and computer vision system will alert the pilot to the real-time altitude and speed. An automated landing probe is deployed, which is a retractable carbon fiber rod fixed to the underside of the fuselage. When one end of the probe touches the ground, the angle change of the probe is detected. This detection automatically adjusts the rotor blade's angle of attack and immediately increases the rotor speed to the maximum, providing the final sufficient lift. This enables our eVTOL to perform a safe, autonomous autorotation landing, achieving a smooth and gentle touchdown superior to a traditional helicopter in normal conditions.

This autorotation landing system is suitable for both manned helicopters driven by electric propeller torque arms and unmanned helicopters driven by EPTA, ensuring a safe autorotation landing.

### BRIEF DESCRIPTION OF THE DRAWINGS

FIG. 01 illustrates the working principle of the helicopter main rotor driven by the electric propeller torque arm. It shows the relationship between the main drive motor and the emergency motor, as well as the positions of the jettisonable main battery pack and the emergency battery.

FIG. 02 displays the aerodynamic principles of the main rotor driven by the electric propeller torque arm, showing the changes in aerodynamic distribution from normal helicopter flight to autorotation landing. Our main rotor is continuously driven unlike traditional helicopters, which is superior to the passive, unpowered autorotation landing of traditional helicopters.

FIG. 03 shows the block diagram of the control system switching to the emergency motor system in the event of a failure of the main drive motor, including power system and voltage drop emergencies.

FIG. 04 illustrates the process of safe autorotation landing of the helicopter driven by the electric propeller torque arm and the function and principle of the landing probe.

FIG. 05 displays the structural diagram of the emergency jettisoning of the main power system and the curve showing changes in rotor disc loading.

### DETAILED DESCRIPTION OF THE INVENTION

In traditional helicopters, the main rotor is driven by a fuel-powered engine that generates the necessary rotational power. Using a clutch and a reduction gearbox, the main rotor is driven to overcome the resisting torque, enabling it to achieve sufficient rotational speed (RPM) to generate vertical lift. However, while the engine drives the main rotor, it also generates a reaction force that causes the fuselage to rotate in the opposite direction. To counteract this fuselage torque, a tail boom and tail rotor are used to balance the engine's output torque and provide directional control for the fuselage's left and right rotation. However, the tail rotor and the entire tail transmission control system consume more than twenty percent of the engine's power. Additionally, the long tail boom often contributes to accidents.

Our patented method of driving the main rotor with an electric propeller torque arm uses the push and pull forces of the propellers to directly rotate the main rotor. This approach not only eliminates the weight, vibration, noise, and emissions associated with the fuel engine system, but also removes the torque imposed on the fuselage by the engine, thus eliminating the need for a tail rotor and tail transmission system to counteract torque. Additionally, it dispenses with the reduction gearbox and clutch system. Compared to traditional helicopters, this method saves 30% of the engine's output power.

Tests have proven that the electric propeller torque arm direct drive is more efficient than traditional helicopters and represents a breakthrough innovation in the design of eVTOL aircrafts. This new model has the potential to become the most successful eVTOL type. Once the new model is established, ensuring safe landing remains the final challenge faced by all eVTOLs. We have not only successfully addressed this challenge but have also achieved a level of performance superior to that of traditional helicopters.

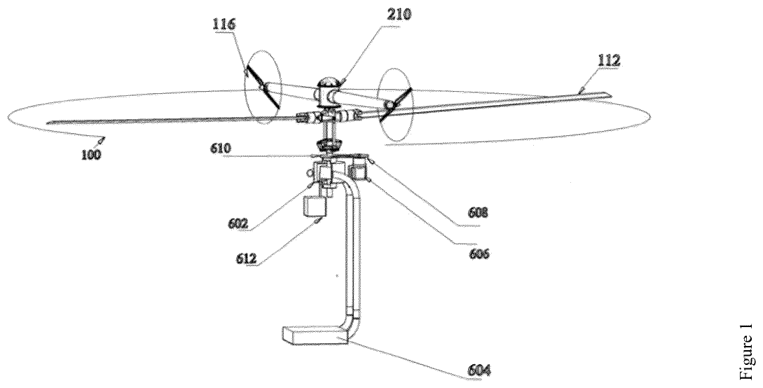

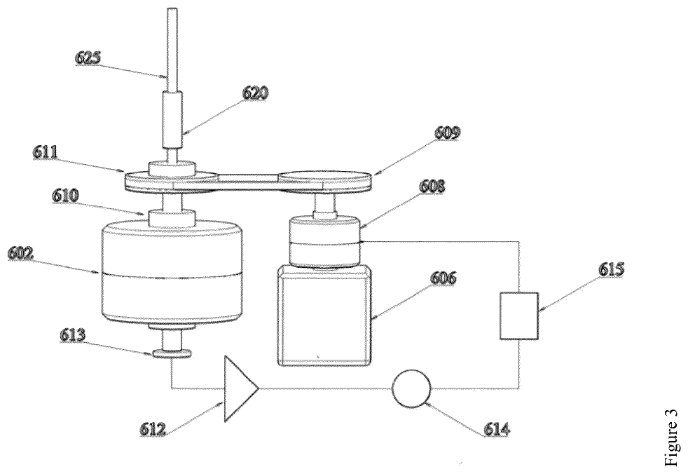

In FIG. 01, 100 denotes the main rotor's plane of rotation, also known as the rotor disc. This area encompasses the sweep of the rotor blades 112. The drive method of the electric propeller torque arm is indicated by 116. It propels the main rotor, achieving the necessary rotational speed (RPM) to generate the lift required for vertical takeoff. To reduce the weight of the torque arm and its rotational centrifugal force, we designed the heavy drive motor to be positioned on the central rotating shaft. The drive gearbox is labeled 210. The main drive motor 602 transmits output torque to the central shaft 625, as depicted in FIG. 03, through a one-way clutch bearing 610. Note that this central shaft 625 is not the mounting shaft of the main rotor 620. Instead, the central shaft 625 directly drives the electric propeller, and its torque is balanced by the push and pull of the propellers, resulting in zero net torque. For the fuselage, only the bearing friction remains.

In the event of a failure in the main drive motor or the primary power supply system, the fault sensor 613 within 612 will cut off the power supply to the main drive motor. This disengages the central drive shaft from the one-way clutch bearing, allowing it to enter a free state. At the same moment, the control unit 615 in FIG. 03 immediately activates the emergency motor 608. This motor continues to drive the central drive shaft 625 through the transmission pulley 609 and a second set of one-way clutch bearings 611, ensuring the electric propeller torque arm continues to rotate the main rotor.

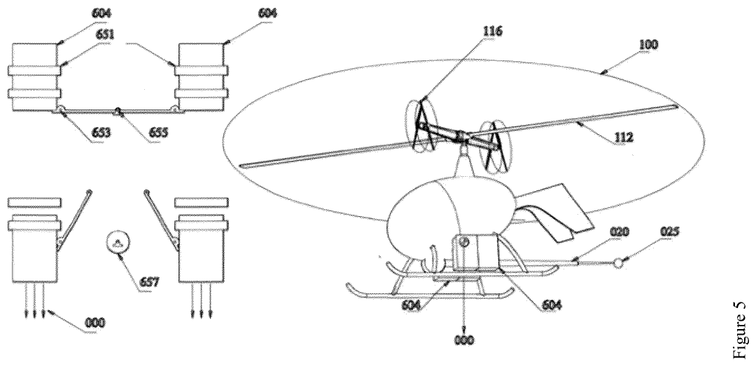

In FIG. 05, the jettison switch 650 immediately releases the locking pin 655. When the battery latch 653 is disengaged, the power supply system 604, including the battery pack, is jettisoned from the aircraft body under the influence of gravity 000. This action instantly reduces the aircraft's total weight by 35%, thereby decreasing the descent rate. This innovative approach has not yet been adopted by other eVTOL designs.

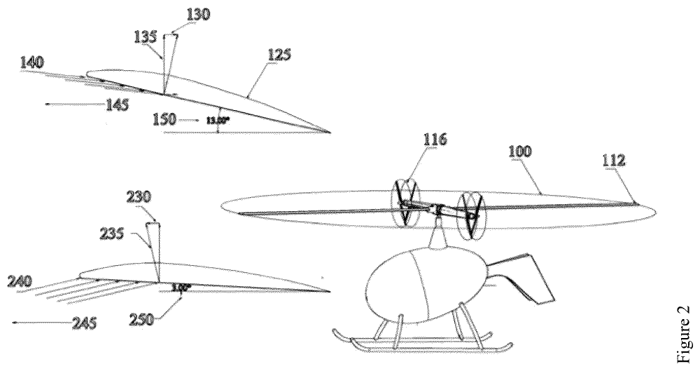

FIG. 02 shows a cross-sectional view of the rotor blade, illustrating the aerodynamic distribution during normal vertical flight of the helicopter. 145 represents the forward driving force of the main rotor, driven by both traditional helicopters and our electric propeller torque arm system. 140 indicates the airflow distribution over the rotor blades, which generates upward lift 135 and backward resisting torque 130. This backward resisting torque is what all aircraft engines must overcome to drive the rotor. The forward driving force 145 achieves this. Typically, traditional helicopters have a profile angle of attack of several degrees, as shown at 150, and our eVTOL follows the same principle.

In the event of a helicopter power system failure, the helicopter must adjust to enter an autorotation state. In this state, the airflow no longer passes through the rotor disc from the upper front but instead flows from the lower front through the rotor disc to the upper rear, as indicated by 240. At this point, the rotor blade's angle of attack is approximately 2°-3°, as shown at 250. The relative airflow 240, with a small angle of attack, generates an upward lift 235. A component of this lift 230 is directed in the same direction as the forward rotation of the rotor, creating a driving torque that continues to rotate the rotor, thereby enabling the helicopter to descend in autorotation. In the aerodynamic distribution across the entire rotor disc, there are also areas where resisting torque is generated. However, as long as the sum of the driving torque and the resisting torque is zero, the rotor will maintain its existing rotational speed driven by its inertia.

This equation is calculated under the condition that the main rotor no longer has any driving force, which applies to the autorotation landing of traditional helicopters. However, our electric propeller torque arm power system surpasses this by continuously providing driving torque to enhance the rotor's autorotation throughout the entire descent process. Particularly in the moments just before landing, our system maximizes the rotor's lift, ensuring a perfectly safe landing.

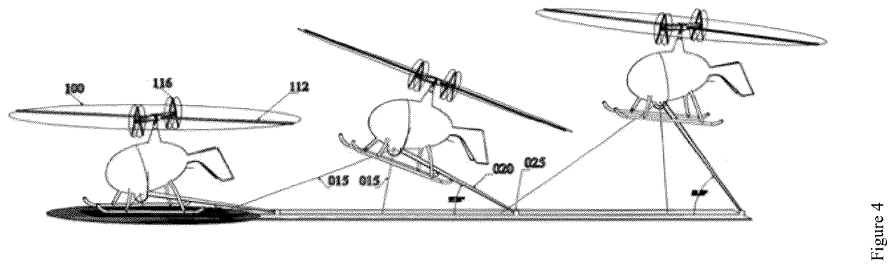

FIG. 04 illustrates the working principle of the electric helicopter's automatic landing system at the moment of landing. Conventional LiDAR and computer vision systems can alert the pilot and enable autonomous control. However, our patent application also features a simple, effective, and cost-efficient control system using a landing probe. At an altitude of 4-5 meters above the ground, the rotor's rotational speed is significantly increased due to our emergency rotor-driving system, greatly reducing the descent speed. The landing probe control system 020 extends outward, contacting the ground at an angle of approximately 60°. As soon as the probe contacts the ground, the rotor blade's angle of attack and the driving force are immediately increased. As the altitude further decreases, the ground contact angle of the probe continuously decreases from 50° to 40° to 30°, and the resistance of the pulse width potentiometer at the base of the probe 020 continuously adjusts the rotor blade's lift angle. This process results in a smooth landing at zero ground speed. Throughout this process, LiDAR sensor, computer vision system, landing probe, and the pilot all work simultaneously, ensuring a safe landing with multiple redundancies.

1. An eVTOL helicopter using an electric propeller torque arm to drive the main rotor, comprising: (1) A main rotor capable of rotating about the main axis of the helicopter to generate lift, with the lift and flight powered directly by the electric propeller torque arm. (2) An electric propeller torque arm that drives the main rotor through a central shaft, utilizing coaxial propellers rotating in left-hand and right-hand directions. This configuration ensures the net torque on the drive motor's output shaft is zero, eliminating the need for a tail rotor, tail boom, and tail transmission system to counteract torque. (3) This helicopter, driven by the electric propeller torque arm, retains and improves the ability of traditional helicopters to perform autorotation landings in the event of a power system failure. Our innovations and enhancements significantly improve the efficiency of the eVTOL helicopter during autorotation, providing a safer autorotation landing capability.

2. The autorotation safety landing of the eVTOL helicopter driven by an electric propeller torque arm according to claim 1, wherein in the event of a failure in the main drive motor or the motor power supply system, sensors monitoring the motor and power supply system detect the failure, immediately cut off power to the main drive motor, and disengage the main central drive shaft from the main motor via a one-way clutch. Simultaneously, a second emergency drive motor and an independent emergency power supply are activated to continue driving the electric propeller torque arm through the central drive shaft, enabling the main rotor to maintain autorotation in an emergency.

3. The autorotation safety landing of the eVTOL helicopter driven by an electric propeller torque arm according to claim 1, wherein if the fault detection system confirms a power supply issue such as a battery pack failure or a sudden voltage drop, the system will immediately jettison the battery pack, which constitutes 35% of the aircraft's weight. This action reduces the rotor disc loading by 35%, thereby decreasing the descent rate and allowing the rotor to better achieve autorotation.

4. The autorotation safety landing of the eVTOL helicopter driven by an electric propeller torque arm according to claim 1, wherein if the fault detection system confirms a failure of the main motor, but the primary power supply system remains functional, the main power supply system can be connected to the emergency drive motor, initiating the emergency autorotation landing procedure. In this case, as the main rotor continues to receive some driving torque, the descent rate of the eVTOL helicopter during autorotation will be reduced, and the remaining driving torque at the moment of landing will enable the eVTOL helicopter to achieve a soft and stable safe landing.

5. The autorotation safety landing of the eVTOL helicopter driven by an electric propeller torque arm according to claim 1, wherein the landing probe system used prior to landing is simple, cost-effective, practical, and reliable. In particular, in our system, the rotor continuously maintains a certain emergency driving torque, sustaining the rotor's autorotation speed. The landing probe system ensures a landing with nearly zero vertical speed.
